(19) United States
(12) Patent Application Publication
(10) Pub. No.: US 2020/0195633 A1
(43) Pub. Date: Jun. 18, 2020

(54) CONTACTLESS CAR SHARING SECURITY PROTOCOL

(71) Applicant: Thunder Power New Energy Vehicle Development Company Limited, Central (HK)

(72) Inventor: Wellen Sham, Taipei City (TW)

(21) Appl. No.: 16/702,585

(22) Filed: Dec. 4, 2019

Related U.S. Application Data
(60) Provisional application No. 62/778,309, filed on Dec. 12, 2018.

(51) Int. Cl. H04L 29/06; H04L 9/32; H04L 9/08; H04L 9/30

(52) U.S. Cl. CPC H04L 63/0823; H04L 9/30; H04L 9/088; H04L 9/3263

(57) ABSTRACT

Embodiments can facilitate contactless vehicle sharing. This may include configure a certificate server to receive from a first user device a first request for a certificate. The first user can be authenticated by the certificate server. In response to the first user being authenticated, the certificate for the first user can be issued by the certificate server. Information regarding registration and/or the certificate for the first user can be distributed to a computer server associated with a contactless car sharing service provider. A second request can be received from the computer server to authenticate a third request from the first user for using a vehicle as received by the computer server. The third request can include the certificate for the first user and the second request can include information regarding the third request. The third request can be authenticated by the certificate server using the certificate.

### CROSS-REFERENCES TO RELATED APPLICATIONS

The present application claims priority to U.S. Patent Application No. 62/778,309, filed on Dec. 12, 2018, entitled “CONTACTLESS CAR SHARING SECURITY PROTOCOL”, which is incorporated by reference herein for all purposes.

### FIELD OF THE DISCLOSURE

The disclosure generally relates to a car sharing network.

### BACKGROUND OF THE DISCLOSURE

Facilitating car sharing is generally known in the art. A traditional form of car sharing is car rental services. Programs, websites and apps have been developed to facilitate a user to reserve a rental car in advance. For example, a user can reserve a rental car online at a website provided by a rental car company. The reservation information is recorded in a database on the rental company and as well as delivered to the pickup location. After the user arrives at the pickup location, a clerk can call up the reservation information and complete the rental transaction with the user. After the rental transaction is completed, the user is then permitted to walk to the car for pickup.

Some other car sharing is facilitated similarly. For example, some car sharing services give their members access cards for accessing shared cars. The access cards typically have a wireless chip. After a member reserves a car, the member can access the car using the access card at a time of the reservation. The car is typically parked at a home location, which may be one of the following: a reserved parking space located on a street, driveway, or neighborhood parking lot in the member's area.

### SUMMARY OF THE DISCLOSURE

Embodiments can facilitate contactless vehicle sharing. This may include receiving from a first user device a first request for a certificate for contactless car sharing. The first request may include user identify information regarding a first user associated with the first user device. In response to the first user request, the first user can be authenticated using the user identity information. In response to the first user being authenticated, the certificate for the first user can be issued. Information regarding the first user and/or the certificate can then be registered in a storage. Information regarding the registration and/or the certificate for the first user to a computer server associated with a contactless car sharing service provider can be distributed. A second request can be received from the computer server to authenticate a third request from the first user for using a vehicle as received by the computer server. The third request can include the certificate for the first user and the second request can include information regarding the third request.

Authentication whether the third request is transmitted by the first user can be performed by transmitting a challenge to the first user device. The challenge can include the certificate. An answer can then be received from the first user, via the first user device. The answer may include information in response to the challenge. The answer can then be verified. In response to verifying the answer, a notification for transmission to the computer server can be generated, the notification can include information indicating the third request is authenticated.

Other objects and advantages of the disclosure will be apparent to those skilled in the art based on the following drawings and detailed description.

### BRIEF DESCRIPTION OF THE DRAWINGS

FIG. 1 generally illustrates a scenario for contactless car sharing.

FIG. 2 generally illustrates a scenario for registering with a certificate server in contactless car sharing.

FIG. 3 illustrates an example of contactless car sharing security in accordance with the disclosure.

FIG. 4 generally illustrates a computer system that can be used to implement various embodiments in accordance with the disclosure.

### DETAILED DESCRIPTION

Car sharing is a model of car rental where people can rent cars for short periods of time. They are attractive to customers who make only occasional use of a vehicle, as well as others who would like occasional access to a vehicle of a different type than they use day-to-day. The organizations providing car sharing services may include commercial businesses, public agency, ad hoc grouping created by users, and/or any other entities. Car sharing is part of a larger trend of shared mobility. Shared mobility includes all modes of travel that offer short-term access to transportation on an on-needed basis either for personal transportation or goods delivery.

In this disclosure, car sharing may also refer to the traditional car rental services that let a user use a vehicle by days.

A self-driving car, also known as a robot car, autonomous car, auto, or driverless car is a vehicle that is capable of sensing its environment and moving with little or no human input. Autonomous cars combine a variety of sensors to perceive their surroundings, such as radar, computer vision, Lidar, sonar, GPS, odometer and inertial measurement units. Advanced control systems interpret sensory information to identify appropriate navigation paths, as well as obstacles and relevant signage.

Contactless car sharing service is a combination of traditional car sharing and self-driving technology. With this service, a user may be enabled to reserve a vehicle of his/her choice using a device associated with this user, for example a smart phone. The vehicle, once successfully reserved by the user, may be dispatched to a pickup location for the user. In this service, the vehicle is typically equipped with self-driving technology. After being dispatched to the pickup location, the vehicle can drive itself to the pickup location. An important aspect of the contactless car sharing is the entire process may be completed without a human operator's intervention. That is, in the traditional car sharing service, some form of human operator's intervention is needed so long as the vehicle is dispatched to a pickup location. For example, in the traditional car rental service, the user is required to physically be present at a car rental location and a clerk typically helps the user complete the rental transaction necessary for the user to access the vehicle. In some more advanced car sharing services, the transactions may be completed online without a human operator's disclosure, but a human operator is still needed to drive the car to the pickup location because cars in those services are not equipped with self-driving technology.

It should be understood the contactless car sharing service concerned by this disclosure is different from the short term car sharing service generally known (e.g., Zipcar). Although, it may be argued that the short term car sharing service is also contactless in the sense no human operator is needed for a user of such a service to access a car provided by the service, this kind of service does not dispatch the car to a pickup location. That is, cars provided by such a service are parked at their home locations and the user is required to go to the home locations to access the car.

Thus, the contactless car sharing concerned by this disclosure involves contactless transaction completion and as well as self-driving of a reserved vehicle to a pickup location. One key technical challenge for facilitating such a service is security. With convenience and efficiency brought by the contactless car sharing, it comes with security challenge. How can a user be trusted when there is no verification of the user by a human operator? In the traditional car rental service, the user is requested to present his/her driver's license for verification during rental process to ensure user's identify. In the traditional car rental services, if the user cannot show his/her driver's license for verification, rental request will be denied. In some more recently developed car sharing service, the user may be requested to register him/her-self with a clerk of the service before he/she can use cars provided by the service providers. After a successful registration, the user may then be given an access card with a unique chip that can unlock cars provided by the services.

The security challenge presented to the contactless car sharing is that even if a user is pre-registered and given an access card, the vehicle will be driven to the pickup location. This may incur liability and security concerns unseen in the traditional car sharing services. For instance, as mentioned above, even in the case of Zipcar, the car is parked at home location, and thus access card can only be used at the car's home location. The user who owns the access card will be responsible for maintaining the access card safely. If the card is somehow lost or stolen, the user can notify Zipcar for a replacement in a timely fashion. However, in the contactless car sharing, the user will request the vehicle to be driven to the pickup location, that request alone needs to be authenticated before the user can even access the car at the pickup location. What if the user's device has been hacked or what if an intruder imposter as the user to make that request? Once the vehicle is on the road and even to the pickup location without the real user knowing, the intruder can break into the vehicle and take the vehicle away illegally.

It would be too much of a responsibility to require the user to ensure his/her device is not to be hacked and when it is hacked it is his/her responsibility for the stolen vehicle. Even it were to become the rules in the contactless car sharing service, no many user would try using this service for fearing incurring unwarranted risked unworthy of the convenience and efficiency brought by this service.

One insight provided by this disclosure is a protocol facilitating the aforementioned contactless car sharing by ensuring the user is who he is when a request is made to use vehicle. Of course, there are a myriad of security measures such as fingerprint recognition, face recognition, etc. to ensure personal security of the user's device. Such personal security is not the focus of this disclosure, however. This disclosure rather focuses on how to prevent a user's identity in car sharing services from being hijacked or faked using another device controlled by the intruder. A key measure provided by this disclosure is to provide a certificate to a user. This certificate may be provided to the user upon verification of user identity. This certificate can include information regarding the user. A certificate authority may be used to issue such a certificate. Once issued, this certificate can then be transmitted to a user device for use. Information regarding the user can also be stored in a database associated with the user. Such a database can be made accessible to computer servers associated with contactless car sharing service providers.

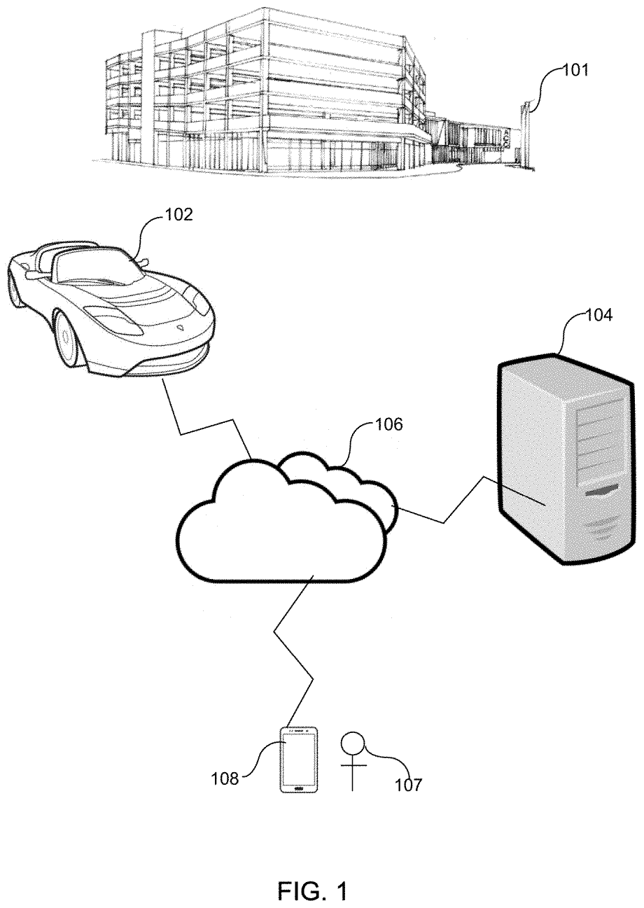

FIG. 1 generally illustrates a scenario where the aforementioned contactless car sharing service is provided. As shown, in the contactless car sharing service in accordance with the disclosure, a parking space 101 may be provided for a vehicle 102. The parking space 101 may be provided by a car sharing service provider, such as a rental car company, a car sharing organizing service, a public agency, or any other entity that may provide the contactless car sharing in accordance with the disclosure. Vehicle 102 may include a car, a bus, a train, a truck, a tram, or any other type of vehicle. Vehicle 102 may be equipped self-driving technology such that it is capable of driving to a location autonomously. In one example, vehicle 102 is an self-driving electrical automobile.

In various embodiments, vehicle 102 may be equipped with one or more communication modules capable of communicating with a remote device wirelessly or through a wire. In various embodiments, vehicle 102 may include one or more processors, such as a vehicle control unit, for processing/generating/executing various instructions and/or commands. As also shown in FIG. 1 is a computer server 104. The computer server 104 may be provided by the aforementioned car sharing service provider to facilitate the contactless car sharing in accordance with the disclosure.

Still shown in FIG. 1 is a user device 108 associated with a user 107. The user device 108 may be configured to communicate with the computer server 104 and/or vehicle 102. As disclosed herein, the user device 108 may be configured help user 107 to perform: reserving vehicle 102 remotely, communicating with computer server 104 and/or vehicle 102 indicating that user 107 is at the pickup location, requesting an access token for accessing vehicle 102 at the pickup location, and/or any other functions. Examples of user device 108 may include a smartphone, a tablet computer, a netbook, a laptop computer, a desktop computer, and/or any other types of user device.

As mentioned above, user device 108 is a key device for facilitating the contactless car sharing. For one this device needs to be reliable when communicating with computer server 104 and/or vehicle 102 when vehicle 102 has been dispatched to the pickup location. This device essentially serves as a point of “contact” for the user 107 in this contactless car sharing service. If somehow the communication with user device 108 breaks down or becomes unreliable before the vehicle 102 is tended to the user 107, the reliability that the vehicle 102 can be tendered to the user 107 at the pickup location cannot be guaranteed. Thus, clear and consistent communication with the user device 108 by computer server 104 and/or vehicle 102 is essential in the contactless car sharing service in accordance with the disclosure. Thus, the aforementioned measures are designed to consistently check-in with the user device 108 and thus the user 107 before the vehicle 102 arrives at the pickup location. Lapse between arrival of the vehicle 102 at the pickup location and user 107's presence at the pickup location may not be tolerated in this contactless car sharing service. Such a lapse may result in the user device 108 being damaged while at the pickup location.

Also shown in FIG. 1 is a network 106, which can facilitate communications among vehicle 102, computer server 104, user device 108 and/or any other devices. Examples of network 106 may include the Internet or a secured communication platform such as vehicle cloud platform. Network 106 is not specifically limited herein and one skilled in the art would understand it may include any type of communication network (wireless and/or wired) to facilitate contactless car sharing in accordance with the disclosure.

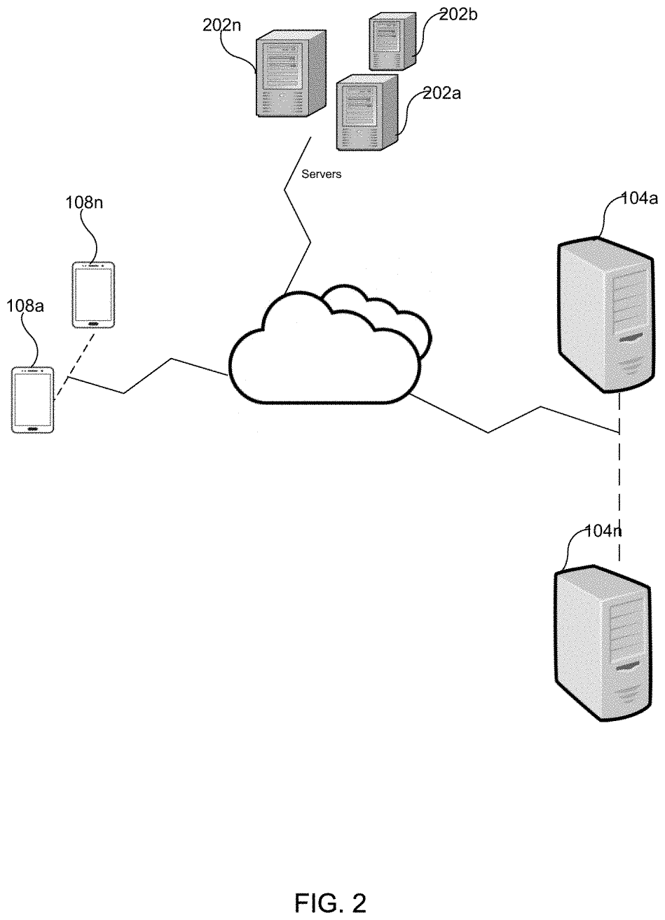

FIG. 2 illustrates one scenario where user devices 108 are registered with certificate authentication servers 202 for the contactless car sharing in accordance with the disclosure. It will be described with reference to FIG. 1. As mentioned above, the authenticity of a request made by user device 108 needs to be verified by computer server 104 of a given contactless car sharing service provider before a requested vehicle 102 can be dispatched to the pickup location. This can be done in advance of the user 107 requests to use a vehicle from any contactless car sharing service provider.

As shown, a given user device 108, such as 108a or 108n, may be configured to facilitate user 107 to request for a certificate for the contactless sharing service. In implementations, this may be achieved by an app or program installed on the given user device 108. By way of example, for instance, the given user device 108 may be authenticated by a manufacturer of the user device 108. When user 107 first uses the user device 108, he/she may register his fingerprint, facial features, and/or any other biological information with the user device 108. In this way, the user 107 is associated with user device 108. Once associated with the user device 108, the user 107 may later initiate a request to obtain a certificate from a given certificate server 202, such as 202a, 202b or 202n as shown.

Various schemes may be used for user device 108 to initiate the request to obtain a certificate. For example, the user device 108 may generate the request to include user identity of user 107 associated with the user device 108. The request may include device information regarding user device 108 such as a unique identifier identifying the user device 108. In some implementations, the generated request may include a public key generated by user device 108. For example, the user device 108 may be configured to generate a private/public key pair and include the public key in the request such that public key is registered with the certificate server 202.

In some implementations, a connection may have been established between the certificate server 202 and the user device 108 before the user 107 initiates the request obtain the certificate from the certificate server 202. For instance, addresses of one or more certificate servers 202 may be configured into user device 108 during a manufacturing of user device 108 such that user device 108 may contact the certificate servers to obtain various certificate including the certificate for use in the contactless car sharing service in accordance with the disclosure.

Once having received the request from the user device 108, the certificate server 202 may be configured to authenticate the request. The authentication may involve extracting user and/or device identity information from the request, verifying the information with one or more known records stored in a database associated with the certificate server 202, and/or any other information. By way of example, as illustration, information regarding the user device 108 may be pre-registered with the certificate server 202 for example during manufacturing of user device 108. In that case, the authentication may simply involve whether the request is indeed transmitted by the user device 108.

When the user makes a request to for the certificate, certain information such as user identity information may presented by the user 107 with the request. From the certificate, user information can then be extracted by the given contactless car sharing service provider. This information can then be compared with information stored in the aforementioned database to find a match. Once a match is found, the contactless car sharing service provider may request the certificate authority to authenticate the certificate. The certificate may include information that can only be decoded by the certificate authority to verify its authenticity. Once authenticated, the contactless car sharing service provider may grant the user access to the vehicle.

In some embodiments, a certificate authority service provider in association with the certificate servers 202 may require the user 107 and/or user device 108 to be authenticated in person or through a notary service after the request is received from user device 108, and before the certificate is issued to the user 107 and stored onto user device 108.

In any case, certificate servers 202 may be configured to issue a certificate to the user device 108 after verifying the request from the user device 108 as described above. The certificate may include user identity information, device identity information, time stamp of issuance, expiration date, and/or any other information. In some embodiments, the certificate may include information that can only be decrypted by the certificate servers 202. For example, certain information may be encrypted in the certificate and stored in the certificate such that only the certificate server 202 can decrypt it.

In some embodiments, the certificate servers 202 may be configured to store user information and/or the certificate information regarding the certificate issued to user 107 in a database. This may facilitate a registration of the user 107 for the contactless car sharing with the certificate servers 202. In some embodiments, certificate and/or the registered information may be distributed to individual computer servers 104 associated with different contactless car sharing service providers. For example, the registered user and/or device information regarding user 107 can be distributed to computer server 104 and stored there as a record that user 107 has been registered with the certificate authority for the contactless car sharing.

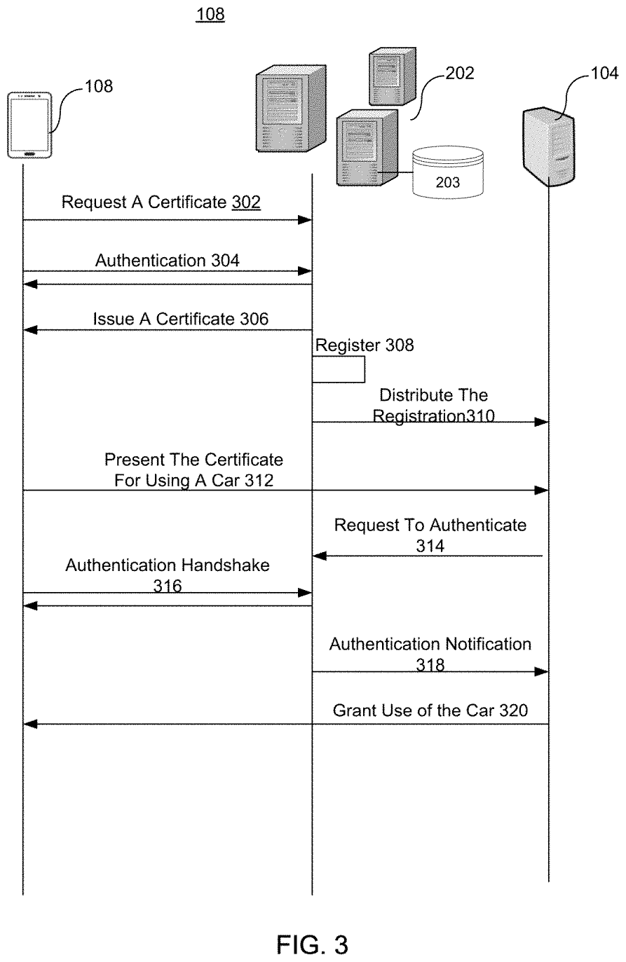

With a scenarios of the contactless car sharing in accordance with the disclosure has been generally described, attention is now directed to FIG. 3, where an example protocol 300 for facilitating contactless car sharing in accordance with the disclosure is illustrated. FIG. 3 will be described with reference to FIG. 1 and FIG. 2.

At 302, a request for a certificate of contactless car sharing service can be generated by user device 108 and transmitted to the certificate server 202. In implementations, this request may be generated by an app or program installed on the user device 108. By way of example, for instance, the user 107 may initiate the request to obtain a certificate from a given certificate server 202, such as 202a, 202b or 202n as shown in FIG. 2.

This request can include information regarding user identity information regarding the user 107, device information regarding user device 108, and/or any other information. The information regarding user 107 can include information indicating an identity of the user, contact information regarding the user 107, insurance information regarding the user 107, driving history regarding the user 107 and/or any other information regarding user 107. The device information may include a unique identity of the user device 108, a make/model of the user device 108, an operating system installed on user device 108 and/or any other information regarding the manner for sharing the vehicle 102. The driving history information may include a driver's license of user 107, one or more driving records for user 107, and/or any other information. In some implementations, the request generated at 302 may include a public key generated by user device 108. For example, the user device 108 may be configured to generate a private/public key pair and include the public key in the request such that public key is registered with the certificate server 202.

At 304, authentication or verification may be performed by the certificate server 202 to authenticate/verify the request received from the user device 108. As described above, various schemes may be used for the authentication/verification. For example, a connection may have been established between the certificate server 202 and the user device 108 before the user 107 initiates the request obtain the certificate from the certificate server 202. For instance, addresses of one or more certificate servers 202 may be configured into user device 108 during a manufacturing of user device 108. The request received from the user device 108 may include information the certificate server 202 knows is associated with user device 108.

As an example, the authentication/verification performed at 304 may involve extracting user and/or device identity information from the request, verifying the information with one or more known records stored in a database associated with the certificate server 202 such as the database 203 as shown, and/or any other information. From the request, the user identify information can be compared with information stored in database 203 to find a match. Once a match is found, the certificate server 202 may verify the request and issue a certificate.

In some embodiments, a certificate authority service provider in association with the certificate servers 202 may require the user 107 and/or user device 108 to be authenticated in person or through a notary service after the request is received from user device 108, and before the certificate is issued to the user 107 and stored onto user device 108. In those example, the certificate server 202 may issue the certificate to the user 107 only after such steps are taken by user 107.

At 306, after a successful verification/authentication of the request transmitted by user device 108, the certificate server 202 may issue a certificate to the user device 108.

At 308, information regarding the certificate and/or user 107 may be registered by the certificate server 202. This may involve storing user information and/or the certificate information in a database. This may facilitate a registration of the user 107 for the contactless car sharing with the certificate servers 202.

At 310, the registration of the user 107 and/or the certificate issued to the user 107 may be distributed to the individual computer servers 104 associated with different contactless car sharing service providers. For example, the registered user and/or device information regarding user 107 can be distributed to computer server 104 and stored there as a record that user 107 has been registered with the certificate authority for the contactless car sharing.

At 312, the user 107 through user device 108 may present the certificate along with a request a vehicle to a computer server 104 provided by a given contactless car sharing service provider.

At 314, the computer server 104 may forward the request to the certificate server 202 and request the certificate server 202 to authenticate the user's request to use the vehicle. In some embodiments, before so forwarding, the computer server 104 may be configured to verify if the user 107 is already registered for using contactless car sharing service. This may involve checking the user registration information distributed by the certificate server 202 at 310 to find a match. Once a match is found, the computer server 104 may then request the certificate server 202 authenticate the user's request.

At 316, the certificate server 202 may perform authentication handshake with the user device 108 to authenticate the user's request transmitted at 312. This may involve inquiring whether the user device 108 has transmitted the request, and/or any other information from the user. In some implementations, the inquiry performed at 316 by the certificate server 202 may be encrypted using the public key of the user device 108 such that the user device 108 is challenged to decrypt inquiry using its private key. Once received an answer from the user device 108, it can be confirmed that the user device 108 has the private key and is verified.

At 318, a notification may be generated to notify the computer server 104 that the user device 108 and/or the request to use the vehicle sent at 312 has been authenticated by the computer server 104.

At 320, a grant may be provided to user device 108 for the user device 108 (and hence user 107) to access the vehicle.

The computer system 400 is shown comprising hardware elements that can be electrically coupled via a bus 404, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 414, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 424, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, an 402.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g. the first electronic device, may be incorporated into the computer system 400, e.g., an electronic device as an input device 414. In some embodiments, the computer system 400 will further comprise a working memory 434, which can include a RAM or ROM device, as described above.

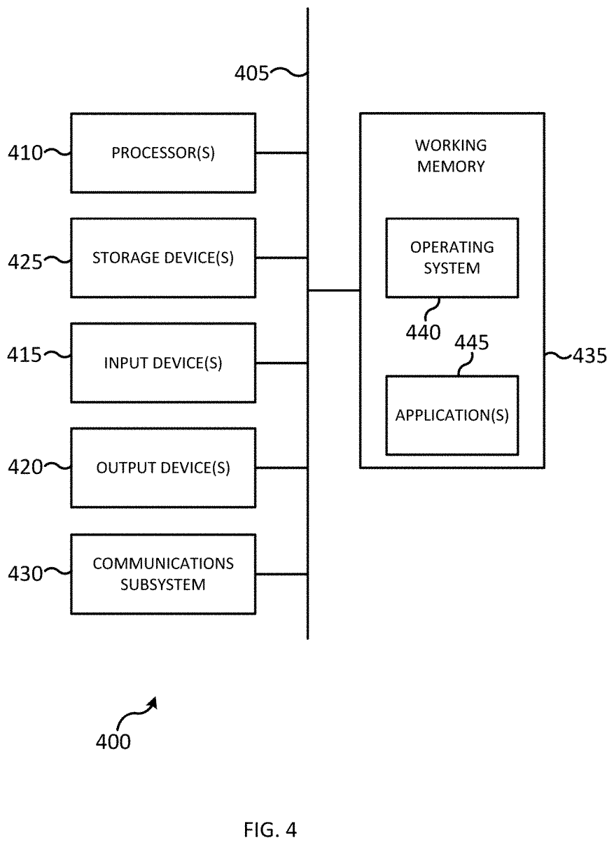

The computer system 400 also can include software elements, shown as being currently located within the working memory 434, including an operating system 440, device drivers, executable libraries, and/or other code, such as one or more application programs 444, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 424 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform methods in accordance with various embodiments of the technology. According to a set of embodiments, some or all of the procedures of such methods are performed by the computer system 400 in response to processor 410 executing one or more sequences of one or more instructions, which might be incorporated into the operating system 440 and/or other code, such as an application program 444, contained in the working memory 434. Such instructions may be read into the working memory 434 from another computer-readable medium, such as one or more of the storage device(s) 424. Merely by way of example, execution of the sequences of instructions contained in the working memory 434 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 424. Volatile media include, without limitation, dynamic memory, such as the working memory 434.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 404 then might carry the signals and/or the data, instructions, etc. carried by the signals to the working memory 434, from which the processor(s) 410 retrieves and executes the instructions. The instructions received by the working memory 434 may optionally be stored on a non-transitory storage device 424 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A method for facilitating contactless vehicle sharing, the method being implemented by a processor configured to execute machine-readable instructions, the method comprising:
receiving from a first user device a first request for a certificate for contactless car sharing, wherein the first request includes user identify information regarding a first user associated with the first user device;
in response to the first user request, authenticating the first user using the user identity information;
in response to the first user being authenticated, issuing the certificate for the first user;
registering information regarding the first user and/or the certificate in a storage;
distributing information regarding the registration and/or the certificate for the first user to a computer server associated with a contactless car sharing service provider;
receiving a second request from the computer server to authenticate a third request from the first user for using a vehicle as received by the computer server, the third request including the certificate for the first user and the second request including information regarding the third request;
authenticate whether the third request is transmitted by the first user by transmitting a challenge to the first user device, the challenge including the certificate;
receiving an answer from the first user, via the first user device, the answer including information in response to the challenge;
verifying the answer; and
in response to verifying the answer, generating a notification for transmission to the computer server, the notification including information indicating the third request is authenticated.

2. The method of claim 1, wherein the first request further includes a public key generated by the first computer device, the public key being associated with a private key also generated by the first computer device.

3. The method of claim 2, wherein the challenge includes encrypted information using the public key and the answer includes decrypted information using the private key.

4. The method of claim 3, wherein verifying the answer includes check whether the decrypted information is correct.

5. The method of claim 1, further comprising:
finding a match of the first user after the second request is received; and, wherein the authentication of the third request is performed after the match is found.

6. The method of claim 1, wherein authentication of the first user is based on a registration of the first user device in the database.

7. The method of claim 1, further comprising:
transmitting the certificate to the first user device for storage.

8. The method of claim 1, wherein the certificate is the first certificate and the challenge is the first challenge, and the method further comprises:
receiving from a second user device a fourth request for a second certificate for contactless car sharing, wherein the fourth request includes user identify information regarding a second user associated with the second user device;
in response to the fourth user request, authenticating the second user using the user identity information regarding the second user;
in response to the second user being authenticated, issuing the certificate for the second user;
registering information regarding the second user and/or the second certificate in a storage;
distributing information regarding the registration and/or the second certificate for the second user to the computer server;
receiving a fifth request from the computer server to authenticate a sixth request from the second user for using the vehicle as received by the computer server, the sixth request including the certificate for the second user and the fifth request including information regarding the sixth request;
authenticating whether the sixth request is transmitted by the second user by transmitting a second challenge to the second user device, the second challenge including the second certificate;
receiving an answer from the second user, via the second user device, the answer received from the second user including information in response to the second challenge;
verifying the answer received from the second user; and
in response to verifying the answer received from the second user, generating a notification for transmission to the computer server, the notification including information indicating the sixth request is authenticated.

9. A system for facilitating contactless vehicle sharing, the system comprising a processor configured to execute machine-readable instructions such that when the machine-readable instructions are executed, the process is caused to perform:
receiving from a first user device a first request for a certificate for contactless car sharing, wherein the first request includes user identify information regarding a first user associated with the first user device;
in response to the first user request, authenticating the first user using the user identity information;
in response to the first user being authenticated, issuing the certificate for the first user;
registering information regarding the first user and/or the certificate in a storage;
distributing information regarding the registration and/or the certificate for the first user to a computer server associated with a contactless car sharing service provider;
receiving a second request from the computer server to authenticate a third request from the first user for using a vehicle as received by the computer server, the third request including the certificate for the first user and the second request including information regarding the third request;
authenticate whether the third request is transmitted by the first user by transmitting a challenge to the first user device, the challenge including the certificate;
receiving an answer from the first user, via the first user device, the answer including information in response to the challenge;
verifying the answer; and
in response to verifying the answer, generating a notification for transmission to the computer server, the notification including information indicating the third request is authenticated.

10. The system of claim 9, wherein the first request further includes a public key generated by the first computer device, the public key being associated with a private key also generated by the first computer device.

11. The system of claim 10, wherein the challenge includes encrypted information using the public key and the answer includes decrypted information using the private key.

12. The system of claim 11, wherein verifying the answer includes check whether the decrypted information is correct.

13. The system of claim 9, wherein the processor is further caused to perform:
finding a match of the first user after the second request is received; and, wherein the authentication of the third request is performed after the match is found.

14. The system of claim 9, wherein authentication of the first user is based on a registration of the first user device in the database.

15. The system of claim 9, wherein the processor is further caused to perform:
transmitting the certificate to the first user device for storage.

16. The system of claim 9, wherein the certificate is the first certificate and the challenge is the first challenge, and the method further comprises:
receiving from a second user device a fourth request for a second certificate for contactless car sharing, wherein the fourth request includes user identify information regarding a second user associated with the second user device;
in response to the fourth user request, authenticating the second user using the user identity information regarding the second user;
in response to the second user being authenticated, issuing the certificate for the second user;
registering information regarding the second user and/or the second certificate in a storage;
distributing information regarding the registration and/or the second certificate for the second user to the computer server;
receiving a fifth request from the computer server to authenticate a sixth request from the second user for using the vehicle as received by the computer server, the sixth request including the certificate for the second user and the fifth request including information regarding the sixth request;
authenticating whether the sixth request is transmitted by the second user by transmitting a second challenge to the second user device, the second challenge including the second certificate;
receiving an answer from the second user, via the second user device, the answer received from the second user including information in response to the second challenge;
verifying the answer received from the second user; and
in response to verifying the answer received from the second user, generating a notification for transmission to the computer server, the notification including information indicating the sixth request is authenticated.
